(19) United States
(12) Patent Application Publication
(10) Pub. No.: US 2024/0399575 A1
(43) Pub. Date: Dec. 5, 2024

(54) SPEED PRESETS FOR DETERMINING THE TRAJECTORY OF KINEMATICS

(71) Applicant: PHYSIK INSTRUMENTE (PI) GMBH & CO. KG, Karlsruhe (DE)

(72) Inventor: Erik MANKIN, Karlsruhe (DE)

(21) Appl. No.: 18/697,280

(22) PCT Filed: Sep. 30, 2022
(86) PCT No.: PCT/EP2022/077249

§ 371 Date: Mar. 29, 2024

(30) Foreign Application Priority Data
Oct. 4, 2021 (DE) 10 2021 125 628.3

(51) Int. Cl. B25J 9/16

(52) U.S. Cl. CPC B25J 9/1664; B25J 9/1623

(57) ABSTRACT

A method for determining a trajectory in a pose space of kinematic in accordance with a given path of the trajectory is provided. The trajectory is to be traversed here by the kinematic for a certain application. A set of points in the working space of the kinematic, on which a metric of the pose space to be used for determining the trajectory is based, is determined based on the application. Based on the path, the trajectory is determined in such a way that, when the kinematic traverses the trajectory, a pose speed that is based on the metric is smaller than or equal to a predefined maximum speed.

### CROSS REFERENCE TO RELATED APPLICATIONS

This application is a U.S. National Phase application under 35 U.S.C. 371 of International Application No. PCT/EP2022/077249, filed on Sep. 30, 2022, which claims priority to German Patent Application No. 10 2021 125 628.3, filed on Oct. 4, 2021. The entire disclosures of the above applications are expressly incorporated by reference herein.

### BACKGROUND

### Technical Field

The present invention relates to devices and methods for determining a trajectory in the pose space of a kinematic, taking into account a predetermined maximum speed.

### Related Art

A frequently occurring problem in the control system of a robot is the calculation of a trajectory based on a given path in pose space. For safety reasons, for example, speed presets usually have to be observed. An important aspect here is that it is a trajectory in the pose space of the kinematic, however, the speed of the robot is usually to be limited in “real” three-dimensional space. This complicates the handling of such speed presets and can lead to uneven movements of the robot, among other things.

The present invention is thus based on the problem of improving the handling of speed presets when determining trajectories and, in particular, making it more flexible.

### SUMMARY

The problem is solved according to the invention with the features of the independent claims. Some preferred embodiments are the subject-matter of the dependent claims.

The invention is based on the idea of determining a speed of the kinematic based on points in the working space that are adapted to the application to be carried out when determining a trajectory.

According to a first aspect of the present invention, a method for determining a trajectory in a pose space of a kinematic is provided, wherein the trajectory is to be traversed by the kinematic for a particular application. The method comprises a step of (i) obtaining a maximum speed and a path of the trajectory in the pose space; (ii) a step of determining, based on the application, a set of points in the working space of the kinematic on which a metric of the pose space to be used for determining the trajectory is based; and (iii) a step of determining the trajectory based on the path such that when the kinematic traverses the trajectory, a pose speed that is based on the metric is smaller than or equal to the maximum speed.

Generally, in embodiments of the first aspect, the trajectory may correspond to a time course of a position and orientation of the kinematic in accordance with the path; the points indicate respective positions in the working space relative to the position and orientation of the kinematic, and (i) move along with the kinematic when traversing the trajectory such that the relative positions with respect to the position and orientation of the kinematic do not change; and/or (ii) rest in a coordinate system corresponding to the time course of the position and orientation of the kinematic when traversing the trajectory; and (iii) the pose speed corresponds to a maximum speed among speeds at which the points move when traversing the trajectory.

The points can, for example, correspond to a stationary area in the working space, and the pose speed can correspond to a maximum speed among speeds at which the points are swept by a space moving with the kinematic.

Generally, in embodiments of the first aspect, the trajectory may correspond to a time course of a position and an orientation of the kinematic in accordance with the path, and the points include relative points and absolute points. Relative points indicate respective positions in the working space relative to the position and orientation of the kinematic. For example, (i) relative points move along with the kinematic when traversing the trajectory such that the relative positions do not change with respect to the position and orientation of the kinematic; and/or (ii) relative points rest in a coordinate system that corresponds to the time course of the position and orientation of the kinematic when traversing the trajectory. The absolute points correspond to a stationary area in the working space. The pose speed corresponds to a maximum speed among speeds at which (i) the relative points move when traversing the trajectory, and (ii) the absolute points are swept by a space that moves with the kinematic.

Determining the trajectory may comprise, in embodiments of the first aspect, (i) a step of dividing the path into path sections; (ii) a step of estimating a maximum displacement among the displacements experienced by the points when traversing one of the path sections (iii) a step of estimating, based on the maximum speed and the estimated maximum displacement, a time duration in which the path section is to be traversed when traversing the trajectory; and (iv) a step of determining the trajectory such that the path section is traversed in at least the estimated time duration.

For example, the maximum displacement can be estimated based on displacements of one or more of the points located on the surface of a space volume corresponding to the points.

Generally, in embodiments of the first aspect, the trajectory may be determined such that, as the kinematic traverses the trajectory, (i) a pose acceleration based on the metric is less than or equal to a predetermined maximum acceleration, and/or (ii) a pose jerk based on the metric is less than or equal to a predetermined maximum jerk.

In some embodiments of the first aspect, the set of points is determined based on (i) the location of a tool and/or work coordinate system; and/or (ii) the location of a pivot point.

According to a second aspect of the present invention, a control device for controlling a kinematic is provided. The control device is adapted to obtain (i) a maximum speed, (ii) a path of the trajectory in the pose space, and (iii) a set of points in the working space of the kinematic on which a metric of the pose space to be used for determining the trajectory is based. The control device is further adapted to determine the trajectory based on the path such that, when the kinematic traverses the trajectory, a pose speed based on the metric is less than or equal to the maximum speed.

Generally, in embodiments of the second aspect, the trajectory may correspond to a time course of a position and orientation of the kinematic in accordance with the path; the points indicate respective positions in the working space relative to the position and orientation of the kinematic, and (i) move with the kinematic when traversing the trajectory such that the relative positions with respect to the position and orientation of the kinematic do not change; and/or (ii) rest in a coordinate system corresponding to the time course of the position and orientation of the kinematic when traversing the trajectory; and (iii) the pose speed corresponds to a maximum speed among speeds at which the points move when traversing the trajectory.

The points can, for example, correspond to a stationary area in the working space, and the pose speed can correspond to a maximum speed among speeds at which the points are swept by a space moving with the kinematic.

Generally, in embodiments of the second aspect, the trajectory may correspond to a time course of a position and an orientation of the kinematic in accordance with the path, and the points include relative points and absolute points. Relative points indicate respective positions in the working space relative to the position and orientation of the kinematic. For example, (i) relative points move along with the kinematic when traversing the trajectory such that the relative positions do not change with respect to the position and orientation of the kinematic; and/or (ii) relative points rest in a coordinate system that corresponds to the time course of the position and orientation of the kinematic when traversing the trajectory. The absolute points correspond to a stationary area in the working space. The pose speed corresponds to a maximum speed among speeds at which (i) the relative points move when traversing the trajectory, and (ii) the absolute points are swept by a space that moves with the kinematic.

In embodiments of the second aspect, the control device is adapted to (i) divide the path into path sections; (ii) estimate a maximum displacement among the displacements experienced by the points when traversing one of the path sections; (iii) estimate a time duration in which to traverse the path section when traversing the trajectory based on the maximum speed and the estimated maximum displacement; and (iv) determine the trajectory such that the path section is traversed in at least the estimated time duration.

For example, the maximum displacement can be estimated based on displacements of one or more of the points located on the surface of a space volume corresponding to the points.

Generally, in embodiments of the second aspect, the trajectory may be determined such that, when the kinematic traverses the trajectory, (i) a pose acceleration based on the metric is less than or equal to a predetermined maximum acceleration, and/or (ii) a pose jerk based on the metric is less than or equal to a predetermined maximum jerk.

In some embodiments of the second aspect, the set of points is determined based on (i) the location of a tool and/or work coordinate system; and/or (ii) the location of a pivot point.

### BRIEF DESCRIPTION OF THE DRAWINGS

Further details, advantages and features of the invention will be apparent from the following description and the drawings, to which reference is expressly made with respect to all details not described in the text.

FIG. 1 shows a schematic view of an example of serial kinematic.

FIG. 2 shows a schematic view of an example of parallel kinematic.

FIG. 3 shows a schematic view of the relationship between configuration space, working space, direct kinematics and indirect kinematics.

FIG. 4 shows a schematic view of a general determination of a pose metric.

FIG. 5 shows a schematic view of the determination of a pose metric using the DISP metric.

FIG. 6 shows a schematic view of the displacement of relative points when the pose is changed.

FIG. 7 shows a schematic view of a serial robot with 2 degrees of freedom.

FIG. 8 shows a schematic view of the displacements that a relative point undergoes when the robot in FIG. 7 performs an exemplary movement.

FIG. 9 shows a schematic view of the displacements that an absolute point undergoes when the robot in FIG. 7 performs an exemplary movement.

FIG. 10 shows a schematic view of a screw movement.

FIG. 11 shows a flow diagram showing exemplary steps for determining a trajectory.

FIG. 12 shows a block diagram of an exemplary device for determining a trajectory.

FIG. 13 shows a schematic view of the arc length of a path section.

FIG. 14 shows a schematic view of a sequence of poses.

FIG. 15 shows a schematic view of the path lengths corresponding to the sequence of poses shown in FIG. 14.

FIG. 16 shows a schematic view of a first exemplary speed profile.

FIG. 17 shows a schematic view of a second exemplary speed profile.

FIG. 18 shows a schematic view of the displacement of two bodies by changing the pose.

### DETAILED DESCRIPTION

The present invention relates to methods for determining trajectories of kinematics (e.g. of a robot), as well as control devices for determining trajectories, which are adapted to carry out such methods. The invention comprises parallel kinematics as well as serial, hybrid kinematics and in particular also stacked kinematics, e.g. with rotary adjusters.

### Kinematics

In robotics, it is basically distinguished between the main classes of serial and parallel kinematics. While serial kinematics consist of a series of links (e.g. linear axes and/or rotary axes) to form an open kinematic chain, parallel kinematics consist of a number of closed kinematic chains. This is explained in more detail below. There are also so-called hybrid kinematics, which are a combination of the parallel and serial kinematics mentioned above.

### Serial Kinematics

Serial kinematics refers to the classic structure of an open kinematic chain in which the individual axes of movement are arranged one after the other, thus in series. A kinematic chain is therefore a series of several bodies (the links of the chain) that are connected to each other by joints. The individual links of the chain can be rigid bodies or, for example, length-adjustable elements. Depending on the robot, they are also referred to as arm/leg parts.

The joint connects two links and can have different degrees of freedom. The arrangement and type of joints and links have an influence on the path curves that can be described by the individual links. Kinematic chains play an important role in planning and calculating the possible movement of industrial and other robots.

A classic example of a serial kinematic is a SCARA robot (abbreviation for “Selective Compliance Assembly Robot Arm”), in which a specific pose is usually realized with two different configuration vectors.

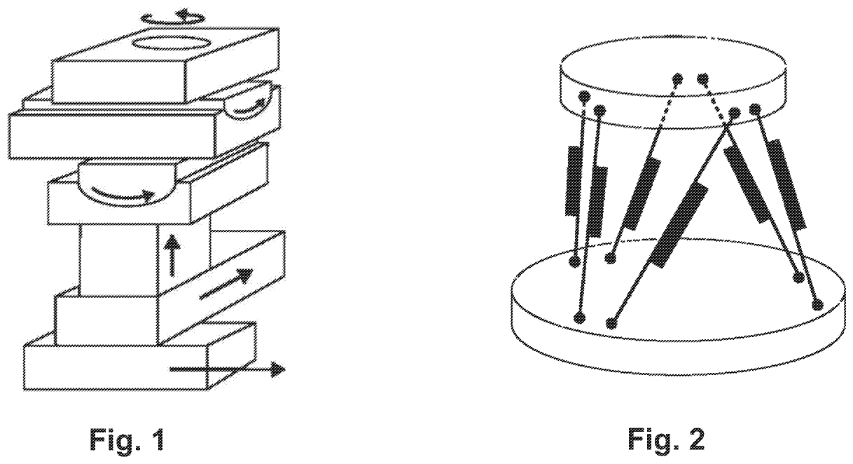

FIG. 1 schematically shows an example of a serial kinematic with several links and joints. As indicated, these links can move linearly in one or more directions, can perform a rotational movement in one plane, have an articulated structure and/or are adjustable in length.

### Parallel Kinematics

Parallel kinematic refers to a kinematic consisting of a number of closed kinematic chains. In practice, parallel rod kinematics are often used for the parallel movement axes, which couple two planes to be moved relative to each other. Each drive is thus directly connected to the (end) effector (e.g. a tool carrier). As a result, the drives are not loaded with the masses of all the following links and drives, as is the case with serial kinematics. As all drives are moved simultaneously, that is, parallel to each other, the loads are distributed (more) evenly across all guide elements. The resulting low moving masses enable extreme dynamics with high speeds and accelerations while maintaining high mechanical precision. Another difference to serial mechanics is that drives, especially the motors and gear mechanisms, remain stationary in parallel kinematics. This not only optimizes the dynamics and performance of such robots, but also their energy balance. Parallel kinematics are therefore often used when simple movement sequences with high repetition accuracy and speed are required. Classic examples of parallel kinematics are hexapods and delta robots.

FIG. 2 schematically shows an example of a parallel kinematic with 6 rod kinematics, thus legs of variable length, and 12 passive joints. The kinematic shown is therefore a Stewart platform, which is also referred to as a hexapod in this specification.

### Pose Space (Pose, Pose Parameters)

A pose is generally understood to be the position and orientation of an object. A pose can therefore be identified with an element of the Special Euclidean Group, SE(3). Poses are specified by so-called pose parameters. The choice of parameterization is not unique. The pose can, for example, be specified by three Cartesian coordinates and three orientation angles in a so-called world coordinate system or base coordinate system. An exemplary parameterization of the pose of a hexapod can be done, for example, by the pose parameters (X,Y,Z,U,V,W). In this context, (X, Y, Z) indicate the position in Cartesian axes/coordinates and can have the unit “millimeters”, for example. (U, V, W) are angles, e.g. Cardan angles (360/360), a sub-type of Euler angles, and indicate the orientation or rotation.

The world coordinate system thereby remains fixed in the space and is independent of the movement of the robot. It is therefore also said that the pose is given in world coordinates. The description of the pose is therefore space-related, i.e. position and orientation are described in “real” three-dimensional space, the so-called working space. However, it is also possible to (uniquely) specify a pose using other coordinates or parameters. In the following, the term pose parameter therefore generally refers to those coordinates or parameters that are used to specify a pose. In this context, a pose corresponds to a specific value for each of the pose parameters. These values can be combined to form a vector of pose parameters that uniquely characterizes a pose. Conversely, a pose is defined or specified by specifying a vector of pose parameters, thus by specifying a value for each of the pose parameters. In particular, the pose parameters can also be “normal” world coordinates (thus, for example, three spatial coordinates to specify the position and three angles to specify the orientation).

The term pose here refers, for example, to the pose of an end effector of the respective kinematic. In this context, the end effector refers, for example, to the last link in a kinematic chain. It is usually the component or assembly for carrying out the actual handling task. In other words, the effector causes the actual interaction of the robot (i.e. the kinematic) with its environment. In particular, an end effector can be a tool, a tool carrier, a gripper, or a platform to be moved (e.g., in the case of hexapods).

The pose space here refers to the space of theoretically conceivable poses, thus the set of possible positions of a rigid body in space. A pose therefore corresponds to an element of the pose space. The pose space can be identified with the special Euclidean group SE(3), which consists of all rotations and translations in Euclidean space. Each element from SE(3) thereby corresponds (exactly) to a pose (and vice versa). More precisely, an element from SE(3) is identified with the pose that results when that element is applied to a given reference pose. There are many parameterizations of the working space, or of SE(3). One possible parameterization is the specification of a displacement plus Cardan angle. The displacement can be specified, for example, by the distance to a reference point in Cartesian coordinates. The Cardan angles indicate the orientation. Instead of Cardan angles, actual Euler angles or other angles can of course also be used.

It should further be noted that a robot is generally not able to actually realize any pose, e.g. of the end effector, in the pose space. On the one hand, the poses that can actually be assumed are limited by the geometry of the kinematic, in particular the length of the links. Furthermore, a robot does not have to have 6 degrees of freedom for the joints. In this case, the space of poses that can actually be assumed will generally not be 6-dimensional and a pose can be specified by fewer than 6 parameters. It is conceivable, for example, that the robot's freedom of movement (e.g. the position of the effector) is restricted to one plane.

### Configuration Space (Joint Coordinates)

The configuration space describes the space of possible configurations of the individual machine components (joints, arms, etc.). It therefore has the dimension of the independent degrees of freedom of the kinematic. These degrees of freedom can be joint angles and/or, for example, lengths of length-adjustable elements (arms/legs). The individual joint coordinates (angles, lengths) can be combined to form a configuration vector, thus a vector in the configuration space. This corresponds to a representation of the configuration space as a Cartesian product of the individual value ranges corresponding to the joint coordinates (angle ranges and/or length ranges).

In the case of a Stewart platform (also known as a hexapod), for example, the configuration space is given by the six variable leg lengths and a configuration vector specifies a corresponding length for each of the six legs. The configuration space K_{Hex} of a hexapod can therefore be understood as the Cartesian product of the individual intervals corresponding to the possible lengths of the legs

$${K}_{Hex} = {\prod }_{i = 1}^{6} [ {L}_{min} ( i ) , {L}_{max} ( i ) ] = [ {L}_{min} ( 1 ) , {L}_{max} ( 1 ) ] \times … \times [ {L}_{min} ( 6 ) , {L}_{max} ( 6 ) ]$$

wherein Lₘᵢₙ(i) and Lₘₐₓ(i) indicate the smallest or largest possible (permissible or used) length of the i^{th} leg.

### Direct Kinematics

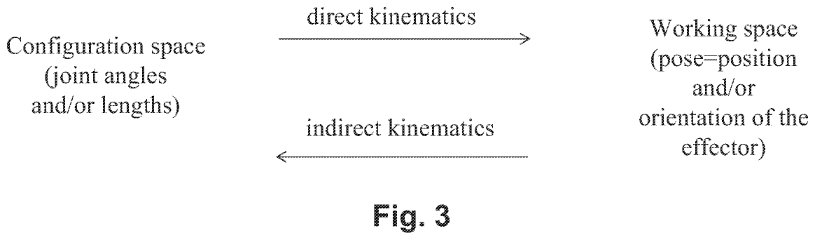

As illustrated in FIG. 3, direct kinematics, forward kinematics or forward transformation deals with the question of how the pose (position and orientation) of the end effector can be determined from given joint angles and/or given lengths of length-adjustable links of a robot. It is the logical counterpart to indirect kinematics. Direct kinematics therefore allows the pose to be calculated from given leg lengths and/or leg angles, i.e. from a given configuration vector, and corresponds to a mapping from the configuration space to the working or pose space.

### Indirect Kinematics

Indirect kinematics, inverse kinematics, inverse-kinematics or backward transformation converts a position and orientation of the effector given by world coordinates or pose parameters into the individual joint coordinates. As illustrated in FIG. 3, it is therefore the logical counterpart to direct kinematics and corresponds to a mapping from the working or pose space into the configuration space. Indirect kinematics therefore allows the calculation of joint angles and/or lengths of the links from a given pose. It should be noted that indirect kinematics does not have to be unique. In other words, it is possible that a given pose can be realized by different configuration vectors. This is often the case with SCARA robots, for example.

A calculation of the indirect kinematics is typically necessary when a specific pose (target pose) is to be assumed and therefore a joint configuration corresponding to the target pose is required. The kinematic can then be controlled with the determined configuration vector, for example to assume the target pose. This control may include the calculation of a path in the configuration space based on the current configuration vector and the configuration vector corresponding to the target pose as the start or end point of said path. The kinematic can thus be made to run through a trajectory, the end point of which corresponds to the target pose.

### Trajectory and Path

The sequence of poses is called a path. The sequence can, for example, be an uninterrupted sequence of poses assumed by the kinematic.

This is distinguished from the term trajectory, where path speeds are also defined. More precisely, the time course of the poses assumed by a robot during a movement is referred to as a trajectory. In other words, a trajectory is a mapping from a time interval into the pose space. The image of this mapping forms the pose set of the path. It should be noted here that there are many different trajectories for a path, i.e. different trajectories can have the same path.

A common task in robotics is the determination of a trajectory based on a given path (and the specification of which end of the path corresponds to the start pose and/or which corresponds to the end pose). In this context, a trajectory is to be determined so that the kinematic runs through the poses of the path in the sequence specified by the path when running through the trajectory. The determined trajectory thus corresponds to a time course of a position and orientation of the kinematic in accordance with the path.

Thus, when determining the trajectory, the speed at which the robot traverses the path in each pose of the path is determined-based on a metric of the pose space and the resulting length of the path. A certain speed preset, which refers to the speed of the robot in the working space, should usually be maintained.

### Metric Form

A metric form is a metric on a pose space that can be expressed as a function of a qualified point set of the working space and a metric of the working space. A point set is qualified if only the pose transformation of the identical mapping of this set maps all point coordinates of the point set onto itself. For example, a set consisting of only one point cannot map rotations around this point to a pose change.

### Metric-Establishing Set

As explained in more detail below, according to the invention, a metric-establishing set of working space points is used to define a pose metric based on a set metric. The metric-establishing set may or may not be a point set of a finite number of points of the working space. The metric-establishing set is a qualified point set.

In this way, speed presets can be effectively and flexibly defined and/or taken into account when determining trajectories, especially when calculating trajectories. Since a pose metric defines a distance between 2 poses, it is now also possible to calculate path lengths and speeds in pose space, e.g. by dividing path sections of defined length by the corresponding times at which the path sections are traversed. A metric-establishing set makes it clear (or defines) at which point in the working space the set system speed corresponds to the local prevailing point speeds, because with rotations the point speeds in the working space are location-dependent and also depend on the position of the pivot point or the current axis of rotation. Points with a large distance to the pivot point have the highest speeds. By using metric-establishing sets, it is possible to define which Cartesian speeds and angular speeds should be present in the moving fiber end during fiber alignment. Comprehensive control of the scanning speeds can, for example, improve the scanning result. In particular, speed limits in the immediate vicinity of a fiber alignment can make the scanning speeds easier to control and improve the results.

By using a metric-establishing set, for example, it is possible to ensure that all points in a freely selected small volume move at least approximately at the same specified system speed. In a large volume, the speed definition can be based on the fastest points in the volume. All types of rotational movements, in particular the axis of rotation of the rotational movements as well as the position of the pivot point—also in connection with Cartesian movements—can be controlled. This flexibility improves the accuracy of scanning processes in particular, as the angular speeds can be coupled to the Cartesian speeds locally using a freely selectable factor.

It is also possible to reduce the risk of collision. Once a collision detection algorithm has determined areas of imminent approach, safe speed presets can be set locally. Freely configurable and changeable speeds in volumes and/or of bodies moved along with them provide a technological upgrade of hexapods in micro-assembly, as surgical robots, machine tools, etc.

The metric-establishing set can be defined, for example, in the working space via host software or freely selectable in the working space via controller commands. This set can be obtained, for example, by combining individual points, spheres and the like. In particular, individual points of a sensitive apparatus can be added to the metric-establishing set as speed points to be controlled.

This parameterizes a metric on poses and thus makes it possible to define a speed related to this set, which is referred to here as set speed or pose speed. Since the pose speed is related to the metric-establishing set and there is a close relationship between the pose speed and the speeds of the points of this set, the term set speed, which is identical to pose speed, is introduced for better clarity. The pose speed can be a speed averaged over a part of the path or a time interval.

This allows uniform speed presets for Cartesian movements, rotational movements and mixed movements. One advantage of this set speed is that an enclosing volume around things to be moved can be used to define a suitable metric and thus ensure that the fastest point “on or within the things” moves at most at the system speed (that is, the specified maximum speed).

The system speed is a maximum speed specified for the entire trajectory, which should not be exceeded. The system speed is therefore the maximum speed at which the robot should move when traversing the trajectory, which does not always have to be (but can be) the maximum speed actually reached or achievable. In particular, the system speed can be the target speed of the trajectory, thus the speed that the robot should have when traversing the trajectory. It can therefore be a target speed for the system (thus the robot), which should be realized when traversing the trajectory. The system speed is a parameter for designing a time-optimized trajectory while complying with any other boundary conditions (e.g. limited acceleration). For short paths in particular, it is often the case that a target system speed cannot be achieved due to limiting maximum accelerations.

This allows speeds to be specified safely, quickly and easily. Furthermore, the speeds can be tailored specifically to the bodies to be moved.

The points of the metric-establishing set can be relative points and/or absolute points. In other words, the points of the metric-establishing set can contain relative points and/or absolute points. As explained below, the terms relative points and/or absolute points refer to the transformation behavior of the points when the position and/or orientation of the kinematic changes. The displacement distances of relative points are therefore treated differently algorithmically in comparison with absolute points.

### Relative Points

Relative points indicate positions in the working space relative to the position and orientation of the kinematic. They move with the kinematic when traversing the trajectory in such a way that the relative positions do not change with respect to the position and orientation of the kinematic. In other words, relative points rest in a coordinate system that corresponds to the time course of the position and orientation of the kinematic when traversing the trajectory. A relative point is therefore a point that is subject to pose transformation when it is moved along, because one aspect of every pose is a transformation or coordinate transformation.

Relative points can, for example, be points in the working space of the kinematic that move along with the kinematic when traversing the trajectory and correspond to the shape of a body that is moved along (e.g. a tool). They can envelope the body or define an envelope of the body. The term “body moving along” can refer to the moving platform or the end effector, which are also moved along. However, it can also be another object, such as a tool or other object. Relative points can also be located inside the body or near the body, for example, if it is an estimated shape of the body. A true estimation of the maximum speed of all points of the body is possible if the convex envelope of body points embeds, i.e. contains, the body.

At this point, it is noted that the term position and orientation of the kinematic in the present application refers, for example, to the position and orientation (i.e. the pose) of an end effector of the kinematic.

The world coordinates \vec{a}(P) of a relative point a thus depend on the pose of the kinematic. The pose transformation of a point \vec{a} can thereby be described by the equation \vec{a}(P)=\hat{R}\vec{a}+\vec{T}, wherein \hat{R} is the rotational matrix corresponding to the pose P und \vec{T} is the translation vector corresponding to the pose P.

Thus, if the kinematic e.g. assumes the pose p₀ and if the position of the relative point relative to the position and orientation of the kinematic is identified with \vec{a}, the world coordinates \vec{a}(p₀) of the relative point corresponding to the pose are given by

$$\vec{a} ( {p}_{0} ) = {\hat{R}}_{0} \vec{a} + {\vec{T}}_{0} ,$$

In this case, R₀∈SO(3) indicates the orientation (rotation) of the pose p₀ in the world coordinate system and \vec{T}₀∈ [symbol] ³ the position of the pose p₀ in the world coordinate system (displacement/translation with respect to the origin of the world coordinate system). The world coordinates \vec{a}(p₀) of a relative point thus change with changes of the position and/or the orientation of the kinematic, while its position a relative to the position and orientation of the kinematic does not change.

Relative points can be used to specify the speed of individual bodies moved along. The speeds of bodies moved along can thus be specifically influenced. This makes it possible to command speeds that are far above our usual system speeds. This applies, for example, to bodies that are attached to the moving platform via a boom and are therefore pivoted over a wide range during angular rotations. Consider, for example, the movement of engine hoods carried along during car assembly. Hoods would then normally be considerably larger than the robot/hexapod itself.

### Absolute Points

Absolute points indicate respective positions in the working space. Absolute points therefore correspond to a stationary area in the working space, e.g. the convex envelope given by the absolute points. Of course, an absolute point can also be expressed relative to a pose of the kinematic, but its position in world coordinates does not change if the position and/or orientation of the kinematic changes. In other words, the world coordinates of an absolute point remain unchanged when the position and/or orientation of the kinematic changes, while its relative position to the position of the kinematic changes.

An absolute point therefore does not move along with the kinematic when it traverses a trajectory. Absolute points can be used to limit the speed in places where there is a risk of collision, that is, to define a protection zone (where people can be present, for example).

The possibility of speed presets within arbitrary space volumes improves the results of scan algorithms, for example in fiber alignment. The control of Cartesian spatial speeds is also improved when it comes to protecting sensitive equipment and the like with local speed limits.

### Pose Metric

The pose metric assigns a non-negative, real function value to each pair of poses. The term here includes functions that fulfill the mathematical criteria of a metric. However, other suitable functions can also be used, such as heuristic functions, which are pseudometrics, for example, or are not defined on the entire pose space, etc. The metric can be changed at will during operation of a kinematic system or adapted to the respective application. This can be done in particular by changing/adjusting the metric-establishing set of points (adding and/or removing points) and or the underlying standard of [symbol] ³.

The distance between two poses defined by a pose metric is also referred to as the pose distance or set distance. A pose speed can then also be defined based on this metric. This pose speed is thus related to a set of points in the working space consisting of moved along and/or non-moved points. The speed of the fastest point in this set of points corresponds by definition to the current pose speed for a preferred metric. The set speed is, for example, the set distance divided by the time, the pose distance is equal to the set distance caused by the pose transformation. The speed of poses in the pose space is therefore broken down to point speeds in [symbol] ³. The pose speed includes Cartesian movements and at the same time the angular speeds of the pose. Similarly, a pose acceleration, a pose jerk, a pose snap etc. can be defined.

The definition of a distance concept of poses, in particular a metric, makes it possible to specify a single maximum speed, also referred to here as the system speed. It is therefore not necessary to specify both a translational speed and an angular speed. Angular speeds and translational speeds are linked to each other. The system speed is then the set speed and refers to the speed occurring at its points in a preferred metric. The system speed is therefore based on the set distance. The occurring set distances can in turn be influenced by the choice of a suitable metric-establishing set. The metric-establishing set can be adapted opportunistically at any time depending on the situation.

In order to define a distance between two poses p₁ and p₂ and/or a pose metric, any suitable function can generally be used that depends on (not necessarily all) displacements of the points of the metric-establishing set in the world coordinate system (for the relative points) and/or the (virtual) displacements in the moved along coordinate system (for the absolute points). In particular, a function that depends on the magnitudes of these displacements, based on any standard defined on [symbol] ³ can be used as a pose metric. The pose metric is thus determined by the set metric defined above, which depends on the metric-establishing set. These can be points that correspond to a moving rigid body/bodies and/or stationary space area(s).

For example, a path is given from the start pose P(0) of a movement to the target pose P(n), which may be divided into further sections. The complete sequence of poses on the path is P(0), P(1),P (2) . . . . P(n), n>0. It should be noted that the aim is usually to keep the lengths of the individual pose distances very short in order to provide the movement interpolation with many support points during the execution of the movement. It often makes sense to subdivide a point-to-point path into several hundred intermediate positions.

Let a now be a point of the working space, given in world coordinates. The displacement distance of the point between the pose P(s) and P(s+1), s<n, is sought.

A relative point a is considered first. This involves a displacement of the point in world coordinates when the pose changes from P(s) to P(s+1). The point is displaced from \vec{a}(P(s)) to \vec{a}(P(s+1)) within the path section under consideration. In this case \vec{a}(P(s))=\hat{R}(P(s))\vec{a}+\vec{T}(P(s)), as already explained above. The distance of the displacement is therefore ∥\vec{a}(P(s))−\vec{a}(P(s+1))∥. Since the metric shapes are based on point distances, the pose distance between P(s) and P(s+a) is defined by determining the displacement distances of all points of a metric-establishing set.

Now, an absolute point a is considered. It remains unchanged in the world coordinate system, and only its virtual displacement from intermediate pose to intermediate pose is considered, also in world coordinates. When changing from pose P(s) to pose P(s+1), point \vec{a} is virtually displaced towards point \vec{a}(P(s+1°)°P(s)⁻¹).

P(s+1)°P(s)⁻¹ thereby is the pose transformation, which transfers the pose P(s) into the pose P(s+1). P(s)⁻¹ thereby indicates the inverse element of the pose transformation P(s) in SE(3), ° is the linking of pose transformations. Pose, pos transformation and element of SE(3) identify the same. The virtual displacement distance of the absolute point thus has the value d=∥\vec{a}(P(s+1)°P(s)⁻¹)−\vec{a}∥. Since point distances do not change with position transformations, they can be transformed as follows:

$$\begin{matrix}d = ‖ \vec{a} ( P ( s + 1 ) ∘ {P ( s )}^{- 1} ) - \vec{a} ‖ \\ = ‖ \vec{a} ( {P ( s + 1 )}^{- 1} ∘ P ( s + 1 ) ∘ {P ( s )}^{- 1} ) - \vec{a} ( {P ( s + 1 )}^{- 1} ) ‖ \\ = ‖ \vec{a} ( {P ( s )}^{- 1} ) - \vec{a} ( {P ( s + 1 )}^{- 1} ) ‖ .\end{matrix}$$

In this case, the inverse mapping to the position transformation, corresponding to the inverse element from SE(3) of P, can be determined by solving the above equation for \vec{a}, resulting in \vec{a}(P⁻¹)=\hat{R}⁻¹(\vec{a}−\vec{T}).

An example of a set metric is presented below.

### Robot Displacement Metric (DISP Metric)

The metric known as the robot displacement metric assigns the value

$${d}_{A} ( {p}_{1} , {p}_{2} ) := {max}_{{\vec{a}}_{i} ∈ A} ‖ {\vec{a}}_{i} ( {p}_{1} ) - {\vec{a}}_{i} ( {p}_{2} ) ‖ ,$$

to two poses p₁ and p₂, based on a metric-establishing set A, wherein \vec{a}ᵢ(pⱼ)=\hat{R}(pⱼ)\vec{a}ᵢ+\vec{T}(pⱼ), if \vec{a}ᵢ is a relative point; and \vec{a}ᵢ(pⱼ)=\hat{R}⁻¹(pⱼ)(\vec{a}ᵢ−\vec{T}(pⱼ)) if \vec{a}ᵢ is an absolute point. Here ∥ ∥ identifies a standard arbitrarily defined on [symbol] ³, e.g. the Euclidean standard. Thus, each standard induces its own DISP metric and the present invention is not limited to any particular standard. Such a pose distance determined using the DISP metric is also referred to herein as the DISP distance. The distance function thus defined proves to be a metric on poses.

The DISP metric has a special physical meaning if the standard ∥ ∥ is the Euclidean standard. This DISP metric is referred to below as the Euclidean DISP metric.

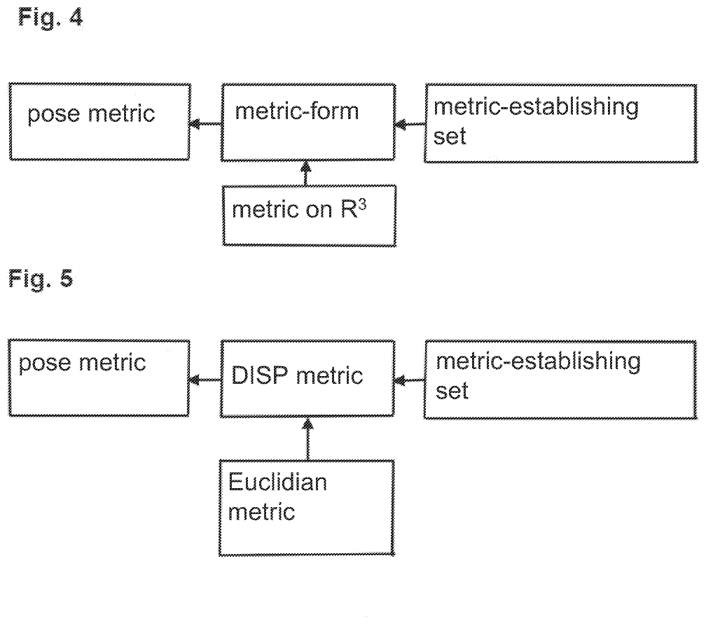

FIG. 4 shows the general case of how a pose metric is obtained from a metric-establishing set, a metric form and an arbitrary metric on R³. The metric form thus forms the pose metric from two arguments.

FIG. 5 shows a preferred case, where the Euclidean DISP metric is formed from the Euclidean metric of R³ and the DISP metric.

If the metric-establishing set contains only relative points, then the maximum displacement in terms of magnitude among the displacements undergone by the points of the metric-establishing set when moving from one of the two poses to the other is assigned to poses p₁ and p₂ as the distance. If the metric-establishing set contains only relative points, then the maximum displacement in terms of magnitude among the displacements undergone by the points of the metric-establishing set when moving from one of the two poses to the other is assigned to poses 1 and 2 as the distance. The distance between two poses is then the maximum distance by which a point of the metric-establishing set is displaced when moving from one of the two poses to the other of the two poses. The pose distance is therefore given by the translation distance of those points of the metric-establishing set that undergo the greatest displacement in terms of magnitude as a result of the translation.

As far as absolute points are concerned, the DISP metric assigns to the two poses p₁ and p₂ the maximum displacement in terms of magnitude among the displacements experienced by absolute points in a coordinate system moving along with the pose from p₁ to p₂. The pose speed of a space volume given by absolute points thus indicates the speed a body assumes when it approaches this space element.

If the metric-establishing set contains relative points and absolute points, the distance between the two poses corresponds in terms of magnitude to the maximum displacement among the displacements of the relative points in the world coordinate system and the displacements of the absolute points in a coordinate system that is moved along (e.g. the TOOL coordinate system). The pose speed then corresponds (in terms of magnitude) to a maximum speed among the speeds with which:
(i) the relative points move when traversing the trajectory (e.g. in the world coordinate system), and
(ii) the absolute points are each swept by a space that moves along with the kinematic (e.g. the TOOL coordinate system) and/or the absolute points move in the TOOL coordinate system when the trajectory is traversed.

The pose speed of a body moved along can therefore, for example, protect a sensitive body moved along from damage by keeping its speed low. The pose speed of a space element, on the other hand, can protect a body that is stationary in the working space from movements of the robot that is located in this space element.

The special case of the DISP metric, in which the Euclidean standard is used, is called the Euclidean DISP metric as described above.

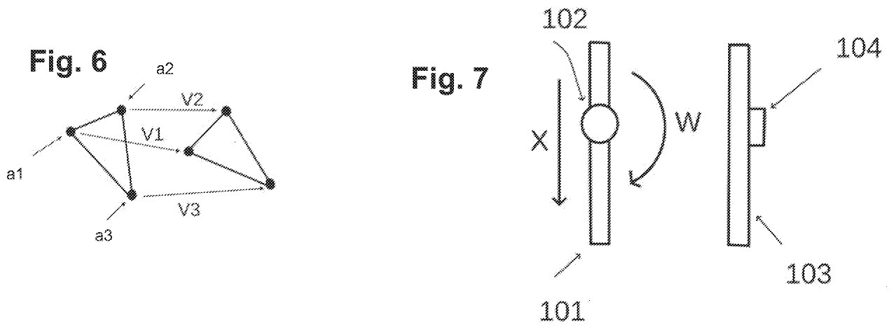

If, as illustrated in FIG. 6, the metric-establishing set contains, for example, three relative points a1, a2 and a3, the DISP metric is given by d_{A,1}(p₁,p₂)=max{∥V₁∥,∥V₂∥,∥V₃∥}, wherein Vᵢ=\vec{a}ᵢ(p₁)−\vec{a}ᵢ(p₂) is the displacement of point AB induced by the transition from pose p1 to pose p2. An example for metric that is different from the DISP metric is given by

$${d}_{A , 2} ( {p}_{1} , {p}_{2} ) = \frac{( ‖ {V}_{1} ‖ + ‖ {V}_{2} ‖ + ‖ {V}_{3} ‖ )}{3} ,$$

wherein ∥ ∥ again is an arbitrary standard, e.g. the Euclidian standard. The d_{A,2} is a preferred metric, the implementation of which can even be worthwhile in parallel or in addition to the DISP metric due to its advantages. Because in this case—if ∥ ∥ is the Euclidean metric—it is possible to specify something like the approximate average speed of a volume, for example by filling a volume with points in a grid-like manner, or by simply placing the volume in a cuboid and considering the 8 corner points and their average displacement amounts.

The metric property of d_{A,1} is discussed below. Let X be an arbitrary set. A mapping d: X x X->R is called a metric on X if the following properties are given for any elements x,y,z of X
1. Positive definiteness; d(x,y)=0⇔x=y
2. Symmetry: d(x,y)=d(y,x)
3. Triangle inequality: d(x,z)<=d(x,y)+d(y,z)

Since our metric-establishing sets are qualified point quantities, the DISP metric satisfies (1).

The DISP metric fulfills (2) by definition.

Property (3) transfers directly from the Euclidean metric of individual points to the metric-establishing set, because the triangle inequality also applies in the Euclidean metric. The same applies to d_{A,2}.

The different treatment of relative and absolute points is now illustrated with reference to FIGS. 7 to 9. FIG. 7 shows a serial robot with 2 degrees of freedom, on the left in top view and on the right in side view. In this robot, a rotary actuator 102, 104 sits on a linear actuator 101, 103. The linear actuator enables movement in the X direction, while the rotary actuator 102 enables superimposed movement in the W direction.

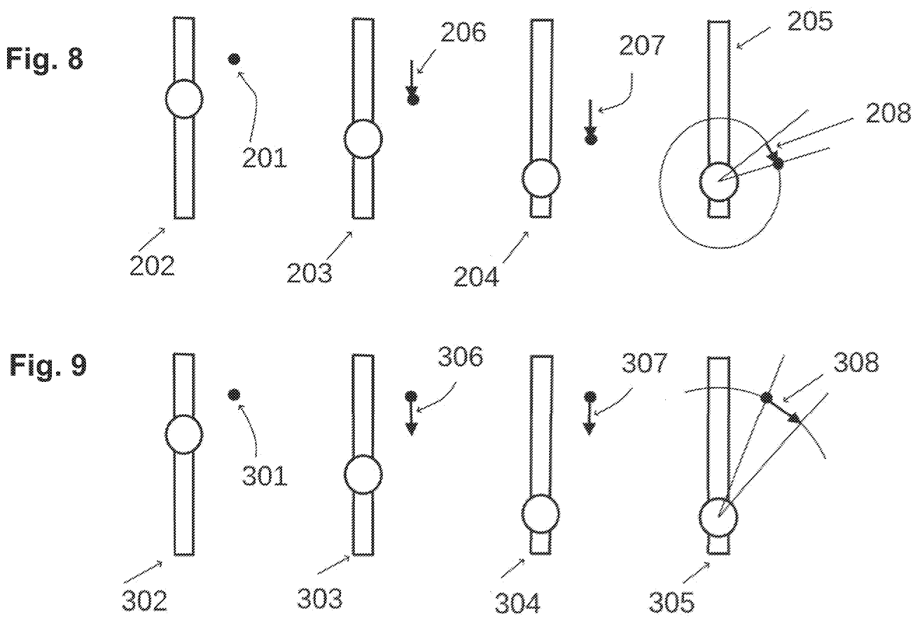

FIG. 8 shows the movement of a body moved along (i.e. simplified here by a relative point) and thus illustrates the handling of relative points. The body 201 moves in the working space when the robot traverses a trajectory. Here, the robot is moved in the pose sequence 202, 203, 204 and 205. A body 201 attached to the rotary actuator follows the movements of the robot. Its position is shown to the right of the robot. The body undergoes displacements in the sequence 206, 207 and 208. The corresponding arrow indicates the direction of the displacement, its length is determined by the metric used. If the movements in the sequence from 202 to 205 are each to be performed at the same pose speed, then a time proportional to the arrow length is assigned to the respective movement. The specification of a uniform pose speed for a body means that the moving body will always have the same speed on the path between two poses. The pose speed of a body is therefore specified here.

FIG. 9 shows the virtual movements of a space volume 301 of the working space. The movement is referred to here as virtual, as the pose of this space volume remains unaffected by the movements of the robot. The robot is again moved in the pose sequence 202, 203, 204 and 205. If the pose of the volume element 301 (represented here by an absolute point) is described relative to the pose of the robot, a variable, dependent pose can be assigned to the volume element. For example, when changing from pose 302 to pose 303, such a displacement occurs, shown by the arrow 306, as the displacement of the point is virtual in contrast to the displacement of the robot. The arrow directions in FIG. 9 are the same as the corresponding arrow directions in FIG. 8. If the movement of the space around the point were considered, the directions would have to be drawn inverted, as it is the apparent movement of the space around a volume element that is of interest. As shown in FIGS. 302 to 305, the spatial element remains in place, but undergoes the virtual displacements 306, 307, 308 one after the other. Based on these displacements, a virtual speed can also be attributed to the spatial element. The path length in FIG. 9 is therefore not obtained by applying the sequence of the original poses to a set of points, but instead by using the sequence of the respective inverse pose changes, wherein each new pose change starts in the original starting pose.

FIG. 8 and FIG. 9 show that distances can be obtained in two different ways based on the same distance function: One considers the case of an object moving with respect to the working space (FIG. 8), the other a stationary object (FIG. 9) in which the environment appears to be moving. It is then shown how different path lengths result from one and the same distance function of the same point set and identical sequence of commanded poses, depending on whether the object is treated as moving or stationary. The different path lengths also lead to a different trajectory or a different speed course. In the example, the length of arrow 208 in FIG. 8 differs from the length of arrow 308, wherein the lengths of the arrows represent the lengths of a path section. This clearly shows that a distinction must be made in the trajectory determination algorithm between the pose speed of a body and the virtual pose speed of a space volume.

Any point set, the convex envelope of which forms a non-empty volume, can be added to or make up the metric-establishing set for the speed definition. Conversely, the corresponding convex envelope can be formed for a finite point set in space that spans a volume. The convex envelope of a qualified point set in the visualization space has the shape of a polyhedron, for example. If the Euclidean DISP metric is used, no point within the polyhedron formed can exceed the maximum point speed in its corners when generating trajectories according to the invention. Sensitive areas can thus be protected flexibly and with little computational effort. The metric-establishing set can also be a sphere in the working space that envelops a sensitive apparatus, for example. In this case, the sphere is enveloped by a finite set of points. The points are added to the metric-establishing set or the metric-establishing set contains points of the sphere volume and/or the sphere surface. In this case, the sphere diameter and sphere origin can be specified. As shown above, no point within a sphere can exceed the set speed of the sphere surface. For easier calculation, a predetermined axis of rotation can be placed in the pivot point or TCP (Tool Center Point) instead of Cardan angles when defining the path. As shown below, this can allow faster calculation of set distances. It should be noted that a sphere can also be approximated with arbitrary precision by a polyhedron, e.g. a regular icosahedron.

### Simplified Calculation of the Set Speed

As explained below, in many cases it is possible to determine the set speed of a set of an infinite number of points such as space volume by determining the set speed of a partial set consisting of a few points, or if necessary only to estimate it. This can simplify the calculation of set speeds considerably.

For example, in general, the maximum displacement can be estimated based on displacements of one or more of the metric-establishing points located on the surface of a space volume, the movement of which is to be considered. In other words, the maximum displacement can be estimated based on displacements of, in particular, a finite partial set of the metric-establishing points. This can be done, for example, based on one, several, or the points located on the surface of a space volume corresponding to the metric-establishing points. In some embodiments, therefore, only the or some of the boundary points are considered for determining the set speed.

### 1) Speed Restriction of Inner Points

It is now shown that the maximum speed of the points of a convex polyhedron is realized by at least one point lying on the surface of the polyhedron. In particular, it is shown that in each point of a polyhedron there is a speed that is less than or equal to the speed of at least one of its vertices (at different times this can of course be a different vertex). This speed restriction gives the Euclidean DISP metric a special meaning, because a speed restriction of the convex envelope of a metric-establishing set consisting of a finite set can be achieved.

Speed is understood here as the magnitude of the speed vector. If the polyhedron only moves translationally, there is nothing to show, as all points have the same speed.

In the following, we will therefore only deal with displacements that also include rotations. The fact that every most general displacement of any body in space can be represented by a screw according to Chasle's theorem is exploited. This concept of a screw also includes the case of a pure rotation.

Chasle's theorem states, as illustrated in FIG. 10, that every displacement of a rigid body is a screw movement, i.e. there is always an axis Q, so that a rotation through the angle w with simultaneous translation h along the axis Q produces the given displacement. H and/or w can assume the value 0.

As can also be seen from FIG. 10, the instantaneous speed of a polyhedron point depends only on its distance from the screw axis. More precisely, the speed of a point increases with the distance from the screw axis. Of course, this can also be shown mathematically. Determining the locations of maximum speed is therefore reduced to a purely geometric task.

In order to demonstrate this statement, the position of polyhedron points is divided into equivalence classes below. It is important to prove here that in some classes it is true for all their representatives that no point has a distance from the axis of rotation that realizes an upper bound of the distance from the axis of rotation, because for each point there is a point with an even greater distance. The existence of a maximum speed in the polyhedron follows from its compactness and the continuity of the speed distribution in the polyhedron.

### 1. The Interior of the Polyhedron

In the interior of the polyhedron, an upper bound of the distance cannot be realized at any point, since in open quantities, by definition, an epsilon environment can be found around each of its points, and each epsilon environment offers a “room to move” towards larger distances.

### 2. The Interior of a Facet

An arbitrary point inside a facet (side face of a polyhedron) is considered. Any two different straight lines that run in the plane of the facet can then be laid through this point.
Case 1: One of the straight lines intersects the screw axis. Then consider an epsilon environment on the degree around this point and conclude the existence of points with an even greater distance to the screw axis. Therefore, no upper bound is realized in the selected point of the set.
Case 2: No straight line intersects the screw axis. In this case, at least one of the two straight lines is at an angle to the screw axis, as at most one of the two straight lines can run parallel to the screw axis. It then gives a straight line through this point that is skewed with the screw axis. If two straight lines are skewed, then they do not have a local maximum with regard to their distance. Therefore, no upper bound of the distance is realized in the selected point of the set.

### 3. The Interior of an Edge

Case 1: The straight line of the edge intersects the screw axis: Consider again an epsilon environment around any point and conclude that other points exist at an even greater distance from the screw axis. Therefore, an upper bound is not realized in any inner point of the edge.
Case 2: The axis of rotation and the straight line of the edge are at an angle to each other. The case of skewed straight lines has already been dealt with above.
Case 3: If the edge is parallel to the axis, then the two bounding corners and the inner edge elements either both belong to the set of points of maximum distance or they both do not belong to it. If there is a maximum distance inside the edge, then the maximum can also be found in the two corner points of the edge.

The overall result is that an upper bound of the distance must be realized in a corner point, and it is then a maximum.

Analogously, it can be shown that no point can be found inside a sphere where the speed is greater than on the surface of the sphere.

### 2) Rotating Sphere

A sphere rotating stably around a straight line has a constant set speed, especially if the straight line passes through its center. A translational movement can be superimposed on the rotation of the sphere. The speeds of all points that lie on the surface of the sphere but not on the axis of rotation will generally change constantly and repeat periodically. The point with the highest speed is also constantly changing. Nevertheless, the set speed remains constant. The input values for calculating the set speed are the direction vector of the translation, the speed of the translation, the radius of the sphere and the angular speed. The result is the direction vector of greatest speed and its magnitude.

If a path from a pose A to a pose B, which includes both rotations and translations, is expressed by a rotation around a straight line with superimposed translation, the trajectory determination is simplified, since the set distances are proportional to the rotation angle or the translation distance on the path. Each rotation in space around a point can be realized as a rotation around an axis of rotation through this point according to Euler's theorem.

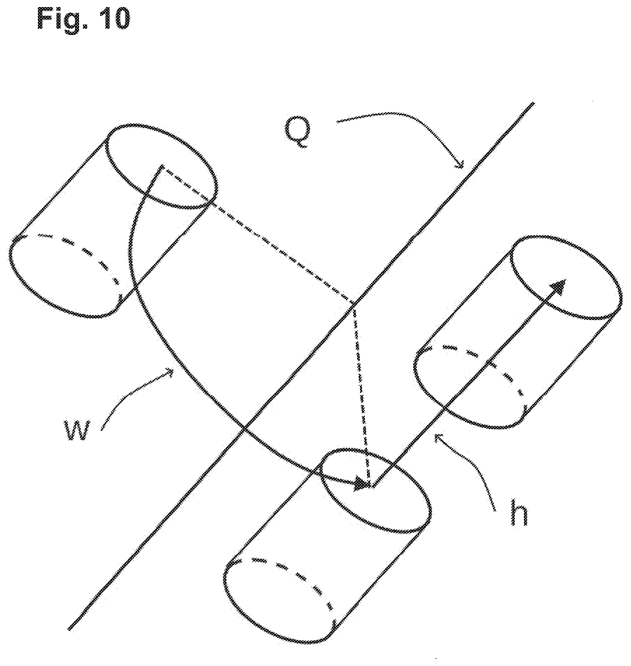

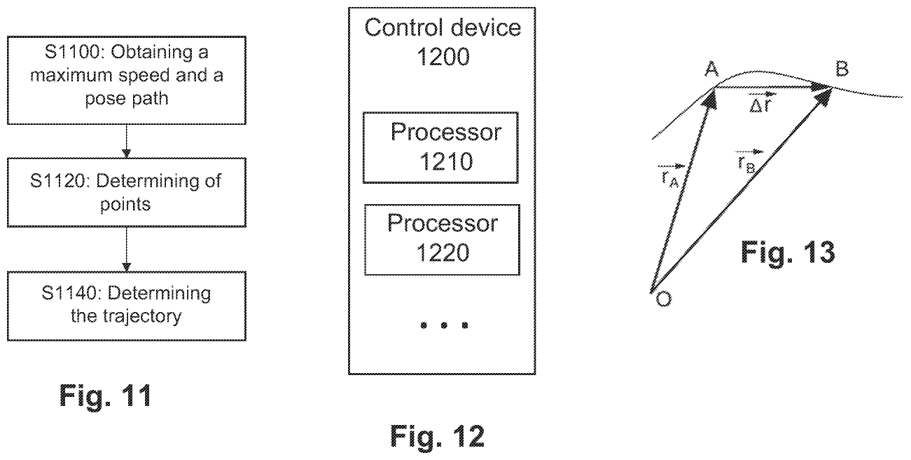

According to the invention, a trajectory of poses is determined based on a pose metric, wherein a path of the poses is predetermined. An exemplary method for determining a trajectory is shown in FIG. 11. The trajectory is to be traversed by the kinematic for a specific application.

The term application can refer to a specific task or activity, that is, e.g. which tools and/or objects the robot moves along when traversing. However, the term application can also (alternatively or additionally) refer to the specific situation, thus circumstances, conditions, environment and/or framework conditions under which such a task is to be performed. This includes, for example, whether and, if so, where people may be present and therefore increased safety conditions must be observed.

The method comprises a step S1120 in which, based on the application, the points of the metric-establishing set are determined. As explained above, these are points in the working space of the kinematic on which a metric of the pose space to be used for determining the trajectory is based. The method includes a step S1100 in which a maximum speed (thus the system speed) is obtained S1100. The method includes a step S1100 of obtaining the path of the trajectory in the pose space. Obtaining the system speed and obtaining the path may be performed in the same step or in separate steps. The path can be obtained by a calculation based on a target pose and an end pose. The system speed can be entered by a user, for example. Steps S1100 and S1120 can take place in any order.

The method further comprises a step S1140 of determining the trajectory based on the given path such that when the kinematic traverses the trajectory, a pose speed based on the metric is less than or equal to the system speed.

According to the method just presented, according to another embodiment, a control device 1200 for controlling a kinematic is provided. Such a control device 1200 is illustrated in FIG. 12 and is adapted to obtain (i) a system speed, (ii) a path of the trajectory in the pose space, and (iii) a set of points in the working space of the kinematic on which a metric of the pose space to be used for determining the trajectory is based. The control device 1200 is further adapted to determine the trajectory based on the path such that, when the kinematic traverses the trajectory, a pose speed based on the metric is less than or equal to the system speed.

The control device 1200 can be implemented in any hardware. For example, it may run as software on a programmable processor 1210. Alternatively, a specialized hardware unit may represent the control device 1200. There may be a mixture of specialized hardware and programmable hardware. In a preferred embodiment, the control device 1200 is distributed and its functions may be performed on multiple processors 1210, 1220 or hardware units. In particular, the functions of controlling the serial or parallel kinematic may be performed by a local control system and the calculation of the interpolation and/or the division of the space into the space units may be performed in an external device, such as a computer. Other configurations are possible.

### Trajectory Determination—Step S1140

In the trajectory determination step S1140, the trajectory is determined based on the given path and the given system speed. The specification of the path can also include a specification of the start and/or end point. More specifically, the trajectory is determined such that (when traversing the trajectory) the pose speed is less than or equal to the system speed. In particular, the trajectory can be determined in such a way that the pose speed is always as high as possible, however less than or equal to the system speed. The system speed can therefore be the target speed when determining the trajectory. If there are also specifications for the pose acceleration, the pose jerk, etc., these are also taken into account. As already mentioned, the trajectory is a mapping from a time interval to the set of poses of the path, wherein the path is traversed from one end to the other. The path defines the sequence of poses that the kinematic must assume. The trajectory also determines the speed at which the given sequence is to be traversed. The trajectory therefore corresponds to a time course of a position and orientation of the kinematic in accordance with the path.

In trajectory determination, the trajectory can be obtained from a given path of poses by assigning a path length to the path based on a pose metric and defining a function of the path length to the elapsed time. The function can be determined according to kinematic pose metric parameters (e.g. pose speed, pose acceleration, etc.). For example, the path can be parameterized according to the path length, s, given by the pose metric. If the path length s(t)=t·vₘₐₓ, wherein vₘₐₓ denotes the specified maximum speed, thus the system speed, is used, the path is traversed at the specified maximum speed. In practice, however, limitations on acceleration, for example, force more complex speed profiles.

For example, the path can initially be divided into several path sections. A division can be obtained by a linear combination of the parameter vector a of the start position and the parameter vector of the target position b. An intermediate position is obtained with a parameter vector c=s*a+(1−s) b with s from]0,1[. The following steps can then be carried out for one, several or all of the path sections, especially when using the DISP metric:
(i) Estimate the pose distance using the point displacement distances of the metric-establishing set. In particular, if Euclidean DISP metric is used, for example, this step can estimate the maximum displacement among the displacements undergone by the points when traversing the path segment. In other words, the pose distance (based on the pose metric) between the two poses corresponding to the two ends of the path segment is calculated here.
(ii) Estimate, based on the system speed and the estimated maximum displacement, a time duration in which to traverse the path section when traversing the trajectory. In this step, the duration can be estimated, for example, by dividing the estimated maximum displacement by the system speed.

The trajectory is then determined in such a way that the path section is traversed in at least the estimated time. This means that the speed in the path section is less than or equal to the system speed.

### Acceleration, Jerk, Etc.

As already mentioned, the pose metric can analogously to the definition of a pose speed, based on a pose metric, also be used to define a pose acceleration, a pose jerk, etc. The method for trajectory determination described for speeds according to the invention can also be applied or extended to the pose acceleration, the pose jerk and the other generalized kinematic variables. In particular, a trajectory can generally be determined starting from a path such that when the kinematic traverses the trajectory: (i) a pose acceleration based on the metric is less than or equal to a predetermined maximum acceleration, and/or (ii) a pose jerk based on the metric is less than or equal to a predetermined maximum jerk.

### Special Coordinate Systems

The speed preset using a metric-establishing set can also be used in conjunction with special coordinate systems, such as the work or tool coordinate system. In particular, the metric-establishing set can be determined based on the position of the tool and/or work coordinate system. The metric-establishing set is thus adapted to the position of the work and/or tool coordinate system by adding and/or removing points. Adjustments can optionally be linked to the position of these coordinate systems via an automatic mechanism so that they are automatically adjusted, for example in the control device, when the configuration of the coordinate systems changes.

If, for example, an engine block is to be machined with a milling cutter, the work coordinate system is attached to the engine block and the tool coordinate system is attached to the milling cutter. The tool, the milling cutter, is moved, work as the position and orientation of the workpiece remains fixed. The tool coordinate system initially refers to the initialization pose of the kinematic and moves with it.

When setting these coordinate systems, points could be set automatically that envelope the origin of the tool coordinate system, for example, or envelope an area around the origin of the work coordinate system. Points around the tool coordinate system define the speeds of the cutter and should be added as relative points to the metric-establishing set. Points around the work origin area can cause all things (such as the cutter) near the convex envelope of these points not to exceed a moderate speed. These points (work coordinate system) must of course not move, thus must be added to a metric-establishing set of absolute points.

In a preferred embodiment, for example, a sphere, approximated for example as a regular icosahedron, is placed around the origin of the tool coordinate system as the metric-establishing set. As a result, the relationship between Cartesian movements and rotational movements does not change when the location of the tool changes, and the trajectory of the rotational movements remains unchanged even after a change in the location of the tool. Again, the angular speeds can be coupled to the system speed via the sphere size.

### Pivot Point(s)

The speed preset using a metric-establishing set can also be used in conjunction with pivot points. In particular, the metric-establishing set can be determined based on the position of a pivot point.

For example, especially for angle scans with fiber alignments, you can set a metric-establishing set in the form of a spherical shell around the pivot point. This means that relative points are used in the moving fiber end. This allows angular speeds to be scaled with respect to Cartesian speeds in their influence on the trajectory by the radius of the spherical shell. If the set is set, the location of the scan can be protected from excessive point speeds. In particular, the radius of a spherical surface on which points are evenly arranged determines the relationship between Cartesian speed and rotational speed when rotating around the center of the sphere (e.g. cutter tip), which is also relevant when moving a tool.

With a suitable layout of a path from a start pose A to an end pose B, the pose parameters of which refer to a pivot point, for example, a simplification and acceleration can be achieved in the trajectory calculation. Euler's theorem is used here, according to which all rotations in R³ around a point can be realized by a rotation around an axis of rotation through this point. It is advisable to use the quaternion calculus to handle the rotations and the transformation in the parameterization of a rotation. The axis of rotation and the angle of rotation result, for example, from the conversion of the change in orientation from pose A to pose B in quaternion representation. When a sphere moves from pose A to pose B, the speed of the fastest point on the surface of the sphere remains constant, as shown above, if the Cartesian speed and the rotational speed are constant and the rotation takes place around an axis of rotation that passes through the center of the sphere. For a sphere translating and rotating around an axis through its center, moving freely “unconstrained in space”, one can find a constant maximum speed that occurs in at least one (also changing) point of the sphere's surface, which is a suitable analogy and corresponds to the path of movement.

If the angular parameters of the path are chosen to be the axis of rotation and the angle of rotation about a fixed axis, thus the quaternion representation, then unnecessary gyroscopic forces do not occur when traversing the path, as is the case with gimbal rotations, which can be relevant for Shaker hexapods and can generally reduce excitations of natural oscillations, e.g. of a hexapod. The transformation matrix also remains constant from pose section to pose section if the pose parameters are linearly interpolated on the path and the path section lengths are the same. Then the rotation matrices do not have to be constantly recalculated. This computational saving can be relevant when using cost-effective control systems for hexapods (flight simulators).

### Arc Length of the Path of a Moving Rigid Body

The calculation of the arc length of the path curve (or also called path) of a moving mass point is illustrated in FIG. 13 to explain the calculation of the arc length of the path of a moving rigid body—or more precisely its pose—as an analogy. The descriptive term “arc length of a path” here means the same as “path length”, which is synonymous with the path length in pose space.

The arc length of the path curve can be calculated by letting the individual moves Δ\vec{r} approach 0 and integrating them. If the curve is parameterized with time, then a speed is assigned to each point on the curve at all times. This is possible in this way for the path of a mass point because a point is moved in a Euclidean vector space. Der Euclidean distance is given (according to Pythagoras) for two-dimensional vectors (a,b) and (c,d) as \sqrt{(a−c)²+(b−d)²}. Such a distance definition is an example of a metric on [symbol] ². If (three-dimensional) rigid bodies are involved, rotations must also be considered. It should be noted that this is not simply about the distance of the center of gravity, for example; instead, rotations should also be included in the concept of distance.

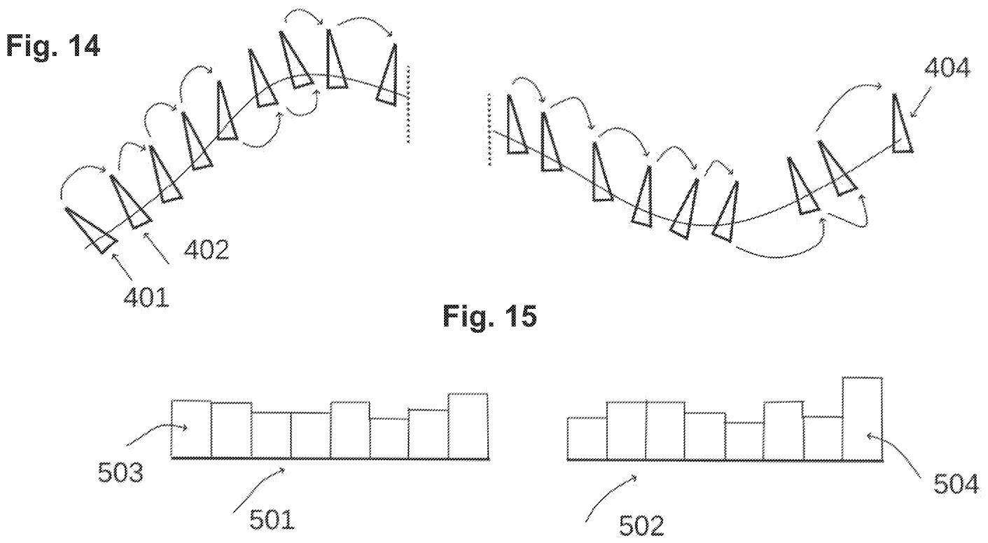

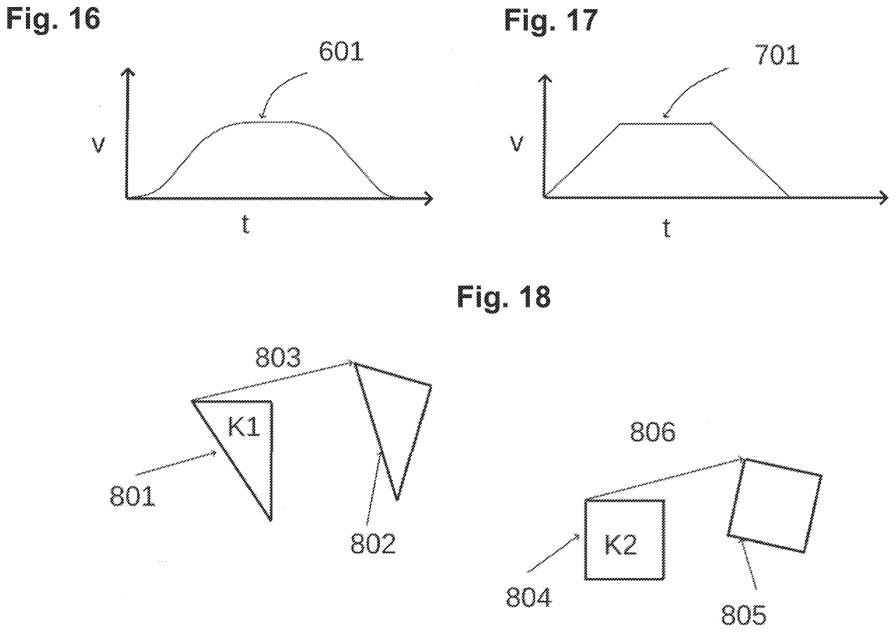

Thus, a distance measure for poses is needed that includes both the twist and the Cartesian displacement, as will now be explained in more detail with reference to FIGS. 14 to 17. FIG. 14 shows a sequence of poses of a two-dimensional body in two-dimensional space, where the Euclidean DISP distance of neighboring poses is shown. FIG. 15 illustrates the extraction of a path length from the pose path of a moving body based on a metric using the pose path shown in FIG. 14. FIGS. 16 and 17 show speed curves that can be assigned to a path as in FIG. 14 and can thus supplement the path to form a trajectory.

FIG. 14 shows an interrupted curved line. The left side describes the first part of a path of a triangular body starting in pose 401, the right side shows the end section of the path. A triangular body in the initial pose 401 is moved, wherein only its three corner points are used to determine the distance between successive poses. On the path, in the sequence from left to right, the triangle is shown in various intermediate poses. The set of intermediate poses on the curved line defines a path, the exact course of which must be determined by interpolation. In the sequence of poses, the displacements and rotations between two poses of the body as well as the irregularities are particularly emphasized in their extent for clarification in FIG. 14. Only the principle is shown here. The metric shown here is the Euclidean DISP metric. The distance between two poses is the maximum of the displacement distances of those points that are chosen for this distance definition, namely the vertices of the triangles. The arrows between the vertices of consecutive triangles, such as 401 and 402, indicate a pair of points that have a maximum distance. This distance is the underlying distance of a distance function between two poses.

In FIG. 15, the distances shown in FIG. 14 are shown as a bar graph. 501 refers to the left section of the path, 502 to the right section of the path. The height of the bars corresponds to the distance between two poses, the width of the bars is 1. The height of bar 503 corresponds to the distance between poses 401 and 402, the last bar 504 corresponds to the distance between pose 404 and its predecessor. The sum of the areas of all bars corresponds to the path length of the path resulting from the sequence of poses. A trajectory can be created by defining the duration of a movement between two successive poses.

In FIGS. 16 and 17, speed profiles are plotted against time. The profiles show the speed profiles that can be obtained by various specifications with appropriate use of the path length by specifying times at which an interval is traversed. The speed profile shown together with the path defines the trajectory. In the illustration in FIGS. 16 and 17, it was assumed that the path is long enough for a target speed to be reached. If the paths were too short for this, the speed curves in FIG. 16 and FIG. 17 would be shown in a qualitatively different way.

FIG. 16 shows a speed profile in S-profile mode. The area under the profile corresponds to the path length. Here the jerk can assume the values {−j, 0, j}, the amount of acceleration is limited to an interval [−a, a]. The amount of the desired maximum speed v, shown here at location 601, corresponds to the system speed selected in the robot controller.

FIG. 17 shows a trapezoidal profile. The area under the profile again corresponds to the path length. This profile is given the path length and the acceleration, which can assume the values {−a, 0, a}, as well as the amount of the system speed, which may also be the target speed, shown here at location 701. The amount of the permissible maximum speed v corresponds to the system speed selected in the robot controller.

In addition to the frequently used speed profiles of FIGS. 5 and 6, a plurality of other speed profiles are conceivable. Speed profiles 5 and 6 are often used for movements between two poses, so-called point-to-point movements. If additional intermediate poses are to be reached or approached on the track, known as VIA points, the speed profiles are usually more complex. The instantaneous speeds presented here using the speed profiles are pose speeds based on a metric on poses. As can be seen, this speed is also the maximum speed of all points of the triangular surface in FIG. 14, which is based on the Euclidean DISP metric. Similarly, the acceleration and jerk of FIGS. 16 and 17, respectively, transfer to the vertices of the triangle as kinematic information.

For highly dynamic kinematics with frequent direction reversals (shaker hexapods), the trajectory determination can also be supplemented by vectorial considerations of speed and acceleration and other parameters. In areas of direction reversal or changes in direction of the path that must be taken into account, for example, the trajectory is given a lower speed, which also leads to lower accelerations, etc.

### Control and Limitation of Leg Lift Speeds

The speed presets in connection with a pose metric initially have no relation to the deflection speeds of the legs in the Stewart platform. The deflection speed refers to the speed of a leg when it is viewed in isolation as a linear actuator. In principle, these deflection speeds must be limited. A simple possibility is to combine the upper six pivot points of the legs FIG. 10, 219 into a metric-establishing set and to limit the pose speed of this set to the maximum permissible deflection speed of the legs. For geometric reasons, this limits the deflection speeds of the legs to this value, wherein the speed of the platform is also limited to a sensible level.

Another possibility is to take the metric-establishing set of the upper six pivot points as the basis of a metric of the configuration space (=joint space) and to consider distances in the configuration space. These resulting distances in the Euclidean DISP metric—this time in configuration space—correspond to the maximum leg deflection speed. In a heuristic way, it is possible to link metrics of the pose space with metrics of the working space and generate a trajectory from them. How metrics can be linked with each other is discussed below under the heading “Simultaneous consideration of several bodies”. Such special considerations of the configuration space are more relevant for serial robots such as industrial robots, as the consideration of leg speeds is of secondary importance for hexapods.

### Simultaneous Consideration of Several Bodies

The determination of speeds based on a single point set with the metric given by it can be generalized, as explained below.

These generalizations can be of considerable benefit. If, for example, handling technology is used in robotics, it is interesting to maintain different maximum speeds (=pose speeds) for different bodies at the same time, i.e. to specify different system speeds. This is because several bodies (space contents) are always moved simultaneously if several bodies are attached to the end effector, or several bodies that are not moving in the reference coordinate system are taken into account.

As a special case of a body, you might want to define a large volume in which the speed is initially limited across the board. This volume could be the immediate surroundings of the moving platform of the robot/hexapod, defined by an enveloping rectangle. As a rule, such an enveloping volume should also be considered. The space contents, the different maximum speeds of which are monitored/defined, may penetrate each other.

The procedure is explained in FIG. 18 for the two-dimensional case using 2 point quantities. Two bodies K1 and K2 are displaced as a result of the same pose transformation. Both bodies are identified below by their corner points. The first body K1 is displaced from the position 801 to the position 802 by a position transformation, the second body K2 is displaced from the position 804 to the position 805 by the same position transformation.

Each of the two bodies defines its own metric, so that two metrics are defined by the two bodies in the pose space. The metrics are identified as M₁ and M₂. This defines two mappings, from a pair of poses (Pₐ,P_{b}) to the non-negative real numbers, that represent metrics. The type of both metrics is identical in the example, e.g. the Euclidean “DISP metric. The pose distances are labeled 803 and 804 respectively.

Based on the mappings M₁ and M₂ a third mapping can be defined

M₃(Pₐ,P_{b}):=max(M₁(Pₐ,P_{b}),M₂(Pₐ,P_{b})).

This mapping is also a metric M₃ and, applied to the two bodies, can limit the pose speed of both bodies equally. Alternatively or additionally, two or more metric-establishing point sets of relative points can also be unified into one metric-establishing point set. Similarly, two or more metric-establishing point sets of absolute points can also be combined to form a metric-establishing point set.

It is also possible to create a new metric using the rule

$${M}_{4} ( {P}_{1} , {P}_{2} ) := max ( {M}_{1} ( {P}_{1} , {P}_{2} ) , s \cdot {M}_{2} ( {P}_{1} , {P}_{2} ) )$$

wherein s is a positive real number, to represent maximum pose speeds. If this metric M₄ is used, the pose speed of body K2 is limited to a maximum pose speed that differs by a factor of 1/s compared to the maximum body speed of K1. The example refers to 2 bodies. However, the method is not limited to 2 bodies.

New metrics can also be created from metrics of the joint space and the pose space in this way.

In summary, the present invention relates to the determination of a trajectory in a pose space of a kinematic in accordance with a given path of the trajectory. Here, the trajectory is to be traversed by the kinematic for a given application. A set of points in the working space of the kinematic, on which a metric of the pose space to be used to determine the trajectory is based, is determined based on the application. Based on the path, the trajectory is determined such that when the kinematic traverses the trajectory, a pose speed based on the metric is less than or equal to a predetermined maximum speed.

1-9. (canceled)

10. A method for determining a trajectory in a pose space of a kinematic, wherein the trajectory is to be traversed by the kinematic for a particular application and the method comprises:
obtaining
a maximum speed, and
a path of the trajectory in the pose space;
determining, based on the application, a set of points in the working space of the kinematic; and
determining the trajectory based on the path such that, when the kinematic traverses the trajectory, a pose speed that is based on a metric is less than or equal to the maximum speed,
wherein the metric is based on the set of points and is a metric of the pose space that defines distances between poses.

11. The method according to claim 10, wherein
the trajectory corresponds to a time course of a position and orientation of the kinematic in accordance with the path,
the points indicate respective positions in the working space relative to the position and orientation of the kinematic, and:
move along with the kinematic during traverse of the trajectory so that the relative positions with respect to the position and orientation of the kinematic do not change; and/or
rest in a coordinate system corresponding to the time course of the position and orientation of the kinematic when traversing the trajectory; and
the pose speed corresponds to a maximum speed among speeds at which the points move when traversing the trajectory.

12. The method according to claim 10, wherein
the points correspond to a stationary area in the working space, and
the pose speed corresponds to a maximum speed among speeds at which the points are swept by a space moving along with the kinematic.

13. The method according to claim 10, wherein
the trajectory corresponds to a time course of a position and orientation of the kinematic in accordance with the path,
the points contain relative points and absolute points,
wherein the relative points indicate respective positions in the working space relative to the position and orientation of the kinematic, and:
move along with the kinematic when traversing the trajectory so that the relative positions with respect to the position and orientation of the kinematic do not change; and/or
rest in a coordinate system that corresponds to the time course of the position and orientation of the kinematic when traversing the trajectory;
the absolute points correspond to a stationary area in the working space, and
the pose speed corresponds to a maximum speed among speeds with which:
the relative points move when traversing the trajectory; and
the absolute points are each swept by a space that moves along with the kinematic.

14. The method according to claim 10, wherein determining the trajectory comprises:
dividing the path into path sections;
estimating a maximum displacement among the displacements experienced by the points when traversing one of the path sections;
estimating, based on the maximum speed and the estimated maximum displacement, a time duration in which the path section is to be traversed when traversing the trajectory; and
determining the trajectory such that the path section is traversed in at least the estimated time duration.

15. The method according to claim 14, wherein
the maximum displacement is estimated based on displacements of one or more of the points located on the surface of a space volume corresponding to the points.

16. The method according to claim 10, wherein
the trajectory is determined so that when the kinematic traverses the trajectory:
a metric-based pose acceleration is less than or equal to a predetermined maximum acceleration, and/or
a metric-based pose jerk is less than or equal to a predetermined maximum jerk.

17. The method according to claim 10, wherein
the set of points is determined based on a position
of a tool and/or work coordinate system, and/or
of a pivot point.

18. A control device for controlling a kinematic, wherein the control device is adapted for obtaining:
a maximum speed;
a path of the trajectory in the pose space; and
a set of points in the working space of the kinematic; and
to determine the trajectory based on the path so that, when the kinematic traverses the trajectory, a pose speed that is based on a metric is less than or equal to the maximum speed,
wherein the metric is based on the set of points and is a metric of the pose space that defines distances between poses.
